(19) United States
(12) Patent Application Publication
(10) Pub. No.: US 2002/0023224 A1
(43) Pub. Date: Feb. 21, 2002

(54) Computer software installation

(76) Inventor: John Aram Safa, Nottingham (GB)

Correspondence Address: SMITH-HILL AND BEDELL, 12670 N W BARNES ROAD, SUITE 104, PORTLAND, OR, 97229

(21) Appl. No.: 09/905,573

(22) Filed: Jul. 13, 2001

(30) Foreign Application Priority Data
Jul. 18, 2000 (GB) 0017478.9

(51) Int. Cl. H04L 9/00

(52) U.S. Cl. 713/190; 713/200

(57) ABSTRACT

When an executable program is to be loaded into RAM 10, the RAM initially contains a loader module 12a, the program 10, an ENGINE 22 and encrypted resources 24, such as encrypted .DLL files. When the program 14 is to be run, the loader module 12a will call the ENGINE 22, which will access the sub-routine resources required by the program 14, identify any of these which are already available in the system, load those already available, and decrypt and load any which are not available. This ensures that the required subroutines are available to the program 14 on each occasion that the program 14 is executed.

The present invention relates to computer software and in particular, to arrangements for installation of computer software.

Modern computer software, particularly applications such as spreadsheets and word processors, is highly complex and makes use of many sub-routines which are called when required by the main executable program. In many cases, these sub-routines may also be required by other applications. For example, a PRINT sub-routine, or sub-routines for FILE OPEN or FILE CLOSE may be usable by a variety of different applications. It has therefore been proposed that in order to save space within system memory, these sub-routines should be shared, where possible. Thus, when installing a new application, it has been proposed that the new application checks the resources already available within the system and makes use of those, where possible. Thus, in the event that a new application requires a later version of a sub-routine than it finds is available within the system, the later version will be installed at the time the new application is installed.

This leads to conflicts between applications. An application already on the system may require an earlier version of the sub-routine which has now been overwritten by the later version required by the new application. This is likely to cause operation of the existing application to become unpredictable or impossible.

The present invention seeks to address these difficulties.

The invention provides computer software which includes an executable program which requires access to at least one sub-routine during execution, the software further including the or each of the sub-routines in encrypted form, and further including a decryption routine operable to convert the encrypted sub-routines to an executable form, at least when access is required.

Preferably the decryption routine is executed whenever the program is executed, whereby to recreate the sub-routines in executable form on each occasion. Preferably the decryption routine creates an address table accessible by the program for locating sub-routines for access. The decryption routine is preferably operable to detect the presence of a sub-routine already available within a system running the software, and to cause the executable program to use a sub-routine already available. The decryption routine may be operable to incorporate within the address table an address for a sub-routine already available, whereby decryption of a further copy of the sub-routine is not required.

The decryption routine is preferably operable to discriminate between different versions of a sub-routine, whereby to decrypt an encrypted version in the event that only a different version is available within the system.

The software preferably further incorporates an encrypted copy of the executable program, the decryption routine being operable to decrypt an executable copy of the program. The decryption routine is preferably operable to decrypt a copy of the executable program in the event that an unencrypted copy contained within the software is detected as being corrupt.

Preferably encryption and decryption include or consist of compression or decompression techniques.

The invention also provides a data storage device containing computer software as aforesaid.

The invention also provides a computer system comprising processing means operable to execute software, and at least one piece of computer software as aforesaid.

The invention further provides a computer system operable to execute an executable program, the system including:

first store means containing computer readable code representing the executable program;

loading means operable to load the code for execution;

identifying means operable to identify any sub-routines required by the executable program during execution thereof;

second store means containing computer readable code representing the or each sub-routine identified by the identifying means;

and second loading means operable to load from the second store means the or each sub-routine in the event that the sub-routine is not available elsewhere within the system.

Preferably the identifying means and second loading means are operated on each occasion that execution of the executable program is initiated, whereby to make the sub-routines available on each occasion. The second loading means may make an entry in an address table to identify the location of a sub-routine which has been made available, the address table being accessible by the executable program for locating sub-routines for access when required. The second loading means are preferably operable to detect the presence of a sub-routine already available within the system, and to cause the executable program to use the sub-routine if already available. The second loading means may be operable to incorporate within the address table an address for a sub-routine available elsewhere within the system. The second loading means is preferably operable to discriminate between different versions of a sub-routine, whereby to decrypt and encrypted version in the event that only a different version is available elsewhere within the system.

The second store means may further contain computer readable code representing the executable program, and the second loading means is operable to load the executable program from the second store means in the event that the executable program is not available elsewhere within the system. The executable program may be held within the second store means in encrypted form, and the second loading means is operable to decrypt the copy, in the event that a copy of the executable program available elsewhere within the system is detected as being corrupt.

Encryption and decryption may include or consist of compression or decompression techniques.

The invention also provides a method of installing a piece of computer software, comprising:

1. Installing an executable program of the type which requires access to at least one sub-routine during execution:

2. Decrypting an encrypted copy of the sub-routine; and

3. Installing the decrypted copy for access by the executable program.

The steps of decrypting and installing are preferably executed on each occasion the executable program is required to be executed.

The method may further comprise the steps of identifying any sub-routines already installed and available to the executable program, and decrypting and installing only the or any required sub-routine which is not so available. The step of identifying sub-routines already available preferably includes discriminating between different versions of a sub-routine, whereby to decrypt an encrypted version in the event that only a different version is already available.

The method may further comprise the step of assessing the executable program for corruption, and decrypting and installing a further copy of the executable program for use in the event that corruption is detected.

Preferably encryption and decryption includes or consists of compression or decompression techniques.

Examples of the present invention will now be described in more detail, by way of example only, with reference to the drawings, in which;

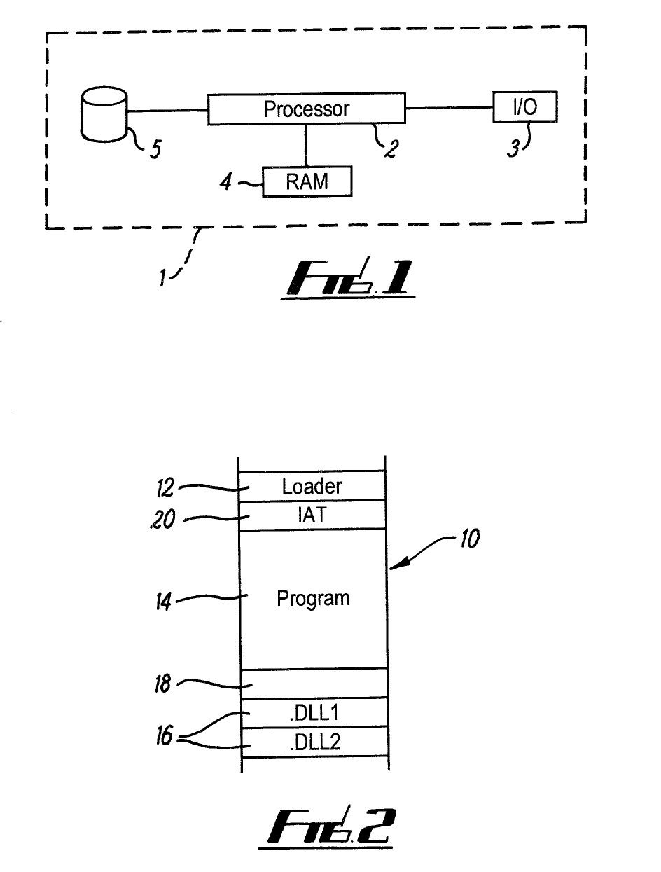

FIG. 1 is a schematic simplified diagram of a data processing device with which the present invention may be implemented;

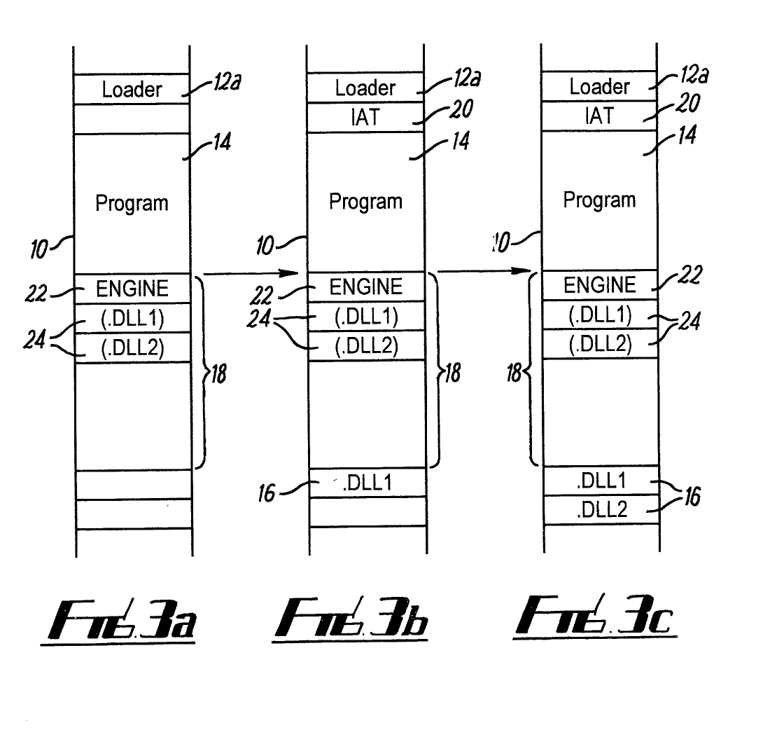

FIG. 2 illustrates RAM with an application installed in accordance with a previous proposal; and

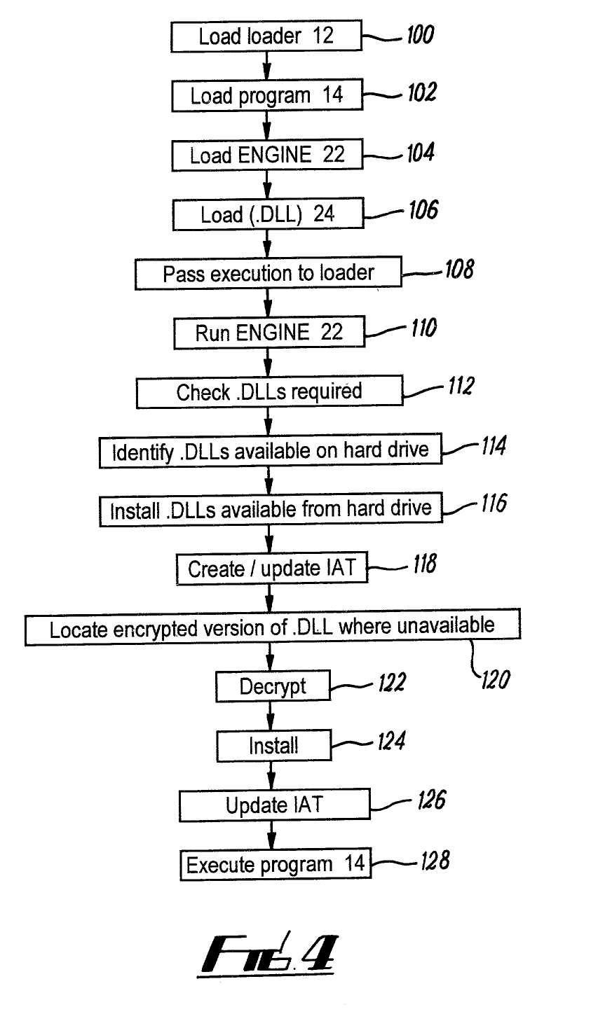

FIGS. 3a, 3b and 3c illustrate the steps for installing an application in RAM in accordance with the present invention.

Before describing arrangements for installing software, it is first helpful to describe the basic components of a data processing system with which the invention can be implemented. FIG. 1 illustrates a computer system 1 which contains a processor 2 to which input/output devices 3 are connected. The processor 2 is also provided with random access memory (RAM) 4 for use during processing. Additional memory capacity is provided at 5, for instance by a hard drive. The computer system may, for instance, be a computer of the IBM PC type, or equivalent.

It is common practice for a software application to be stored on the drive 5 until needed, and then to be installed on the RAM 4, when required for use. This improves speed of access to the software by the processor 2, and thus allows faster processing by the processor 2. FIG. 2. illustrates a section of RAM 10 in which an application (such as a word-processing application) has been installed for use by a processor of a device of the type shown in FIG. 1. The drawing illustrates various components of the application, in highly simplified, schematic form. These include a loader 12, which is a block of code to implement initial operation of the application when first opened. The main body of the program is installed in the RAM 10 at 14. The program 14 will require access to files containing sub-routines, as described above. These are commonly called .DLL files and will be shared by various applications. Accordingly, .DLL files 16 are illustrated in the drawing as being elsewhere in the RAM 10. A region 18 between the program 14 and the .DLL files 16 is free for other use, such as the installation of another application.

The RAM 10 also includes an import address table (IAT) 20. This is a table identifying the location of .DLL files 16 so that the processor 2 may access those files 16 when required by the program 14, by looking up their location in the IAT 20. The IAT is created by the loader 12 when execution is first passed to the loader 12 after the application has been copied to the RAM 10 from the hard drive. The loader 12 checks which .DLL files are required by the applications, finds them on the hard drive, loads them to RAM 10 and creates the IAT 20 to identify each .DLL and its location in RAM.

FIGS. 3a, 3b and 3c illustrate the manner in which an application can be loaded in accordance with the present invention. These can be understood in conjunction with FIG. 4, which is a flow diagram setting out the sequence of steps which are executed as the application is loaded. The steps shown are only those related to the present invention. It is to be understood that other steps, unrelated to the present invention, may also be executed as part of the loading, either before, during or after the steps shown.

Initial loading of the RAM 10 results in the condition illustrated in FIG. 3a. The loader module 12a is in position (step 100 of FIG. 4) and generally corresponds with the loader 12 of FIG. 1. The program 14 is also installed (step 102) at the position corresponding with the installation in FIG. 1. However, it is to be noted in FIG. 3a that the region of memory used for the IAT 20 in FIG. 1 is empty in FIG. 3a.

In accordance with the invention, and as part of the initial loading, an additional block of executable code, called an ENGINE 22 is installed (step 104) in the RAM 10 below the program 14, i.e. in part of the region 18. Other files 24 are associated with the ENGINE 22 and are loaded with it (step 106). These files are encrypted versions of the .DLL files 16 of FIG. 1. Encryption may be by compression or a more secure encryption technique. The files 24 are identified within parentheses in FIG. 3a, to indicate schematically their encrypted nature.

After the initial loading described above, execution is passed to the loader module 12a (step 108). That is, the program pointer of the processor 2 points to the memory address of the beginning of the loader module 12a. FIG. 3b illustrates the changes which then take place within the RAM 10. As part of the initialisation of the application, the loader 12 causes the ENGINE 22 to run (step 110). The ENGINE 22 provides two functions First, the ENGINE 22 will look through the system to identify any resources (i.e. .DLL files, in this example) required by the application (step 112) and identify those already available within the system (step 114). By default, this step 114 also identifies those which are not available. In this simple example, it will be assumed that the sub-routine .DLL1 is required and is available on the hard drive 5, but that the sub-routine .DLL2 is required but not available on the hard drive. The engine 22 is therefore able to locate .DLL1 on the hard drive, copy it to RAM 10 (step 116) and begin to build an IAT 20 by making an appropriate entry in the IAT 20 (step 118) to identify the sub-routine .DLL1 and its location. This results in the condition illustrated in FIG. 3b.

As part of this process, the ENGINE 22 will have identified (at step 114) any required sub-routine which is not already available from the hard drive, or is not available in the appropriate version. In this simple example, sub-routine .DLL2 is not available initially. The ENGINE 22 therefore accesses (step 120) the encrypted file shown as (.DLL2) and then operates (step 122) to decrypt a copy of .DLL2. The decrypted copy is then installed (step 124) to be available to the program 14. Again, the ENGINE 22 makes an appropriate entry in the IAT 20 (step 126) to identify the presence and location of file .DLL2.

Thus, after the ENGINE 22 has fully executed as described, the RAM 10 will be in the condition shown in FIG. 3c. The installation of the application has become equivalent to the installation shown in FIG. 1, there being a loader 12a, program 14, IAT 20 for directing the program to sub-routines, and a full set of DLL sub-routines 16. In addition, some of the empty area 18 of FIG. 2 is now filed with the ENGINE 22 and encrypted (.DLL) files, but these are not called once execution of the program 14 has begun. Execution of the program 14 can now begin (step 128), with the resources required by the program 14 now being available at 16 and identified in the IAT 20.

Incorporating the ENGINE 22 and the encrypted (.DLL) files within the software first installed in the RAM 10 allows a useful technical effect to be achieved, as follows. The application is self-contained, in that it carries with it a full set of sub-routines required for its operation. These are preferably in compressed form to save space, and may be further encrypted for security. They can be installed as described above in the event that they are not already available, or are not available in the correct version. Furthermore, they will be installed, as required, on each occasion the application is run, when the loader module is executed and calls the ENGINE 22. In consequence, correct operation of the application will not be affected by the installation or operation of a different application, however aggressively that other application might modify, replace or over-write shared .DLL files. Any shared files which have ceased to be available as a result of the activity of another application, or for any other reason, will be restored from the encrypted (.DLL) files when the application next runs.

Operation of the ENGINE 22 and the encrypted (.DLL) files also provides a degree of protection against virus attack or other corruption. The ENGINE 22 can be programmed to make an assessment of corruption of sub-routines apparently available from hard drive, installing fresh, unencrypted copies from the (.DLL) files, in the event that any corruption is found or suspected.

In a further extension of the invention, the ENGINE 22 may be provided with an encrypted copy of the main program 14 again with the intention that in the event of any corruption being detected or suspected within the main program 14, a full, fresh copy of the program 14 can be decrypted and installed.

It will be apparent from the above description that many variations and modifications can be made to the arrangements described above, without departing from the scope of the present invention. In particular, it will be apparent to the skilled man that the techniques can be implemented in a very wide variety of languages, and using any of a wide variety of encryption, decryption compression or decompression techniques.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Computer software which includes an executable program which requires access to at least one sub-routine during execution, the software further including the or each of the sub-routines in encrypted form, and further including a decryption routine operable to convert the encrypted sub-routines to an executable form, at least when access is required.

2. The software of claim 1, wherein the decryption routine is executed whenever the program is executed, whereby to recreate the sub-routines in executable form on each occasion.

3. The software of claim 1, wherein the decryption routine makes an entry in an address table to identify the location of a recreated sub-routine, the address table being accessible by the program for locating sub-routines for access when required.

4. The software of claim 1, wherein the decryption routine is operable to detect the presence of a sub-routine already available within a system running the software, and to cause the executable program to use a sub-routine if already available.

5. The software according of claim 4, wherein the decryption routine is operable to incorporate within the address table an address for a sub-routine already available, whereby decryption of a further copy of the sub-routine is not required.

6. The software of claim 1, wherein the decryption routine is operable to discriminate between different versions of a sub-routine, whereby to decrypt an encrypted version in the event that only a different version is available within the system.

7. The software of claim 1, further incorporating an encrypted copy of the executable program, the decryption routine being operable to decrypt an executable copy of the program.

8. The software of claim 7, wherein the decryption routine is operable to decrypt a copy of the executable program in the event that an unencrypted copy contained within the software is detected as being corrupt.

9. The software of claim 1, wherein encryption and decryption include or consist of compression or decompression techniques.

10. A computer readable medium, having a program recorded thereon, wherein the program comprises computer software according to claim 1.

11. A computer system comprising processing means operable to execute software, and at least one piece of computer software according to claim 1.

12. A computer system operable to execute an executable program, the system including:
first store means containing computer readable code representing the executable program;
loading means operable to load the code for execution;
identifying means operable to identify any sub-routines required by the executable program during execution thereof;
second store means containing computer readable code representing the or each sub-routine identified by the identifying means;
and second loading means operable to load from the second store means the or each sub-routine in the event that the sub-routine is not available elsewhere within the system.

13. The system of claim 12, wherein the identifying means and second loading means are operated on each occasion that execution of the executable program is initiated, whereby to make the sub-routines available on each occasion.

14. The system of claim 12, wherein the second loading means makes an entry in an address table to identify the location of a sub-routine which has been made available, the address table being accessible by the executable program for locating sub-routines for access when required.

15. The system of claim 12, wherein the second loading means are operable to detect the presence of a sub-routine already available within the system, and to cause the executable program to use the sub-routine if already available.

16. The system of claim 15, wherein the second loading means is operable to incorporate within the address table an address for a sub-routine available elsewhere within the system.

17. The system of claim 12, wherein the second loading means is operable to discriminate between different versions of a sub-routine, whereby to decrypt and encrypted version in the event that only a different version is available elsewhere within the system.

18. The system of claim 12, wherein the second store means further contains computer readable code representing the executable program, and the second loading means is operable to load the executable program from the second store means in the event that the executable program is not available elsewhere within the system.

19. The system of claim 18, wherein the executable program is held within the second store means in encrypted form, and the second loading means is operable to decrypt the copy, in the event that a copy of the executable program available elsewhere within the system is detected as being corrupt.

20. The system of claim 12, wherein encryption and decryption include or consist of compression or decompression techniques.

21. A method of installing a piece of computer software, comprising:
1. Installing an executable program of the type which requires access to at least one sub-routine during execution:
2. Decrypting an encrypted copy of the sub-routine; and
3. Installing the decrypted copy for access by the executable program.

22. The method of claim 21, wherein the steps of decrypting and installing are executed on each occasion the executable program is required to be executed.

23. The method of claim 21, wherein the method further comprises the steps of identifying any sub-routines already installed and available to the executable program, and decrypting and installing only the or any required sub-routine which is not so available.

24. The method of claim 23, wherein the step of identifying sub-routines already available includes discriminating between different versions of a sub-routine, whereby to decrypt an encrypted version in the event that only a different version is already available.

25. The method of claim 21, wherein the method further comprises the step of assessing the executable program for corruption, and decrypting and installing a further copy of the executable program for use in the event that corruption is detected.

26. The method of claim 21, wherein encryption and decryption includes or consists of compression or decompression techniques.
